(19) United States
(12) Patent Application Publication
(10) Pub. No.: US 2007/0152745 A1
(43) Pub. Date: Jul. 5, 2007

(54) System and method for reducing leakage current of an integrated circuit

(75) Inventors: Yung-Chin Hou, Taipei (TW); Carlos H. Diaz, Mountain View, CA (US); Chung-Hsing Wang, Baoshan Township (TW); Lee-Chung Lu, Taipei (TW)

Correspondence Address: L. Howard Chen, Esq.;Kirkpatrick & Lockhart Preston Gates Ellis LLP, Suite 1700, 55 Second Street, San Francisco, CA, 94105, US

(73) Assignee: Taiwan Semiconductor Manufacturing Co., Ltd.

(21) Appl. No.: 11/322,723

(22) Filed: Dec. 30, 2005

(51) Int. Cl. G05F 1/10

(52) U.S. Cl. 327/544

(57) ABSTRACT

The present invention discloses a system for reducing a leakage current of an integrated circuit coupled to a supply voltage source. The system includes a bias module, and a switch device serially coupled between the bias module and the integrated circuit. The bias module generates a bias voltage and the switch device is turned off for reducing the leakage current of the integrated circuit when the integrated circuit is in a sleep mode.

### BACKGROUND

The present invention relates generally to an integrated circuit (IC) design, and more particularly to a system and method for reducing leakage current of an IC during a sleep mode.

In the past, several techniques have been used to reduce the leakage current generated within the logic components of an IC during a sleep mode in order to avoid unnecessary power consumption. For example, one conventional technique replaces ground with a source bias voltage for generating a bias voltage. As another example, an NMOS transistor is used to decouple the logic components from ground during the sleep mode. While all these techniques reduce the leakage current for the IC, their performances can vary. For example, a circuit implemented with such NMOS transistor can reduce the sleep mode leakage current by around 20 times compared to one without any leakage reduction scheme. By contrast, a circuit implemented with the voltage source bias feature can only reduce the leakage current by 2 times.

As IC designs enter into deep submicron scales, the sleep mode leakage current becomes an important issue and a more efficient leakage reduction scheme may be needed to meet system requirements. The conventional techniques cannot provide a sufficient and satisfactory level of leakage current reduction.

Therefore, desirable in the art of IC designs are systems and methods that can effectively reduce the leakage current during the sleep mode.

### SUMMARY

The present invention discloses a system for reducing a leakage current of an integrated circuit coupled to a supply voltage source. In one embodiment, the system includes a bias module, and a switch device serially coupled between the bias module and the integrated circuit. The bias module generates a bias voltage and the switch device is turned off for reducing the leakage current of the integrated circuit when the integrated circuit is in a sleep mode.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A shows a conventional circuit system for reducing a sleep mode leakage current of an IC.

FIG. 1B shows another conventional circuit system for reducing a sleep mode leakage current of an IC.

FIG. 2 shows a circuit system for reducing a sleep mode leakage current of an IC in accordance with one embodiment of the present invention.

FIG. 3 shows a circuit system for reducing a sleep mode leakage current of an IC in accordance with another embodiment of the present invention.

### DESCRIPTION

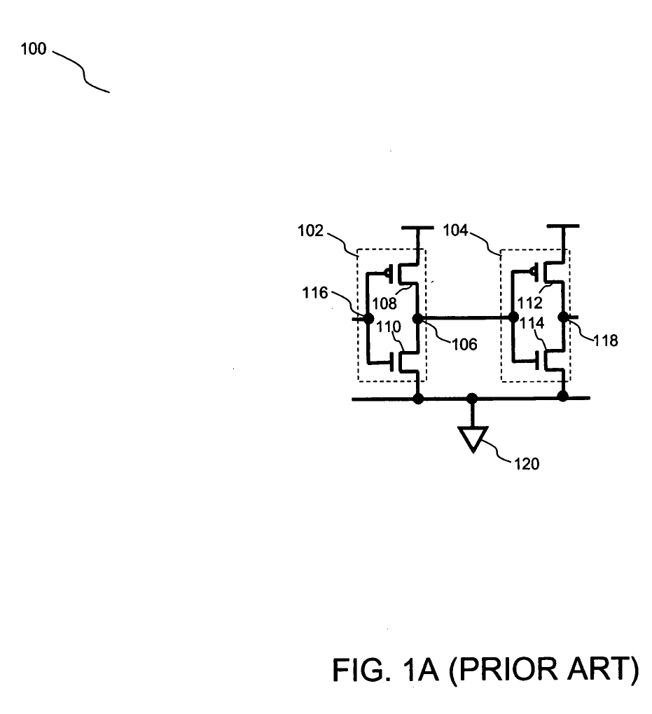

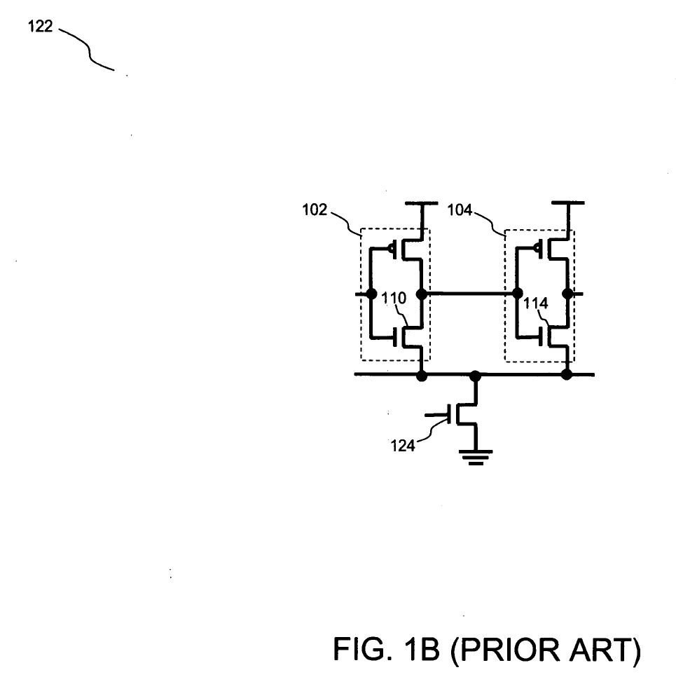

FIG. 1A demonstrates a conventional circuit system 100 for reducing the sleep-mode leakage current. As shown, two inverters 102 and 104 are connected together at a node 106. The inverter 102 includes a PMOS transistor 108 and an NMOS transistor 110, while the inverter 104 includes a PMOS transistor 112 and an NMOS transistor 114. The gates of the PMOS transistor 108 and the NMOS transistor 110 are coupled together at a node 116, which is also the input node of the circuit system 100. The drains of the PMOS transistor 108 and the NMOS transistor 110 are also coupled together to the gates of the PMOS transistor 112 and the NMOS transistor 114 via the node 106. The drains of the PMOS transistor 112 and the NMOS transistor 114 are coupled together at a node 118, which is also the output node of the circuit system 100. The sources of the PMOS transistors 108 and 112 are both tied to a supply voltage source, while the sources of the NMOS transistors 110 and 114 are both tied to a bias module 120.

With both inverters 102 and 104 connected in series, the signals at the nodes 116 and 118 are designed to be inverted as opposed to the signal at the node 106. In other words, when the nodes 116 and 118 are at a low state, the node 106 will be at a high state. This means that only one of the two PMOS transistors 108 and 112 can be turned on at one time, and only one of the two NMOS transistors 110 and 114 can be turned on at one time.

The bias module 120 generates a source bias voltage for the sources of the NMOS transistors 110 and 114. When the circuit system 100 is in a sleep mode, the voltage generated by the bias module 120 is maintained at a level higher than the normal ground voltage. The sleep mode leakage current, which is referred to the current flowing from the supply voltage source to the NMOS transistors 110 and 114 during the sleep mode, can be reduced by the source bias voltage.

While the source bias voltage generated by the bias module 120 is efficient in reducing the leakage current for one of the two NMOS transistors 110 and 114 that is at an off sate, it is not as efficient in reducing the leakage of the other transistor that is at an on state.

FIG. 1B demonstrates another conventional circuit system 122 for reducing the sleep mode leakage current of an IC. The circuit system 122 is identical to the circuit system 100 of FIG. 1A with the exception of the NMOS transistor 124 replacing the bias module 120. The sources of the NMOS transistors 110 and 114 are both coupled to the drain of the NMOS transistor 124. By turning off the NMOS transistor 124 during the sleep mode, the leakage current can be reduced by more than 10 times as opposed to a circuit without any leakage reduction scheme. This can particularly reduce the leakage current for one of the inverters 102 and 104 whose NMOS transistor is turned on.

In deep submicron IC designs, the sleep mode leakage current is an important design issue, wherein a more significant leakage reduction, such as 100 times reduction as opposed to a circuit without any leakage reduction scheme, is often necessary to meet certain system requirements. This makes the leakage current reduction provided by the NMOS transistor 124 alone insufficient.

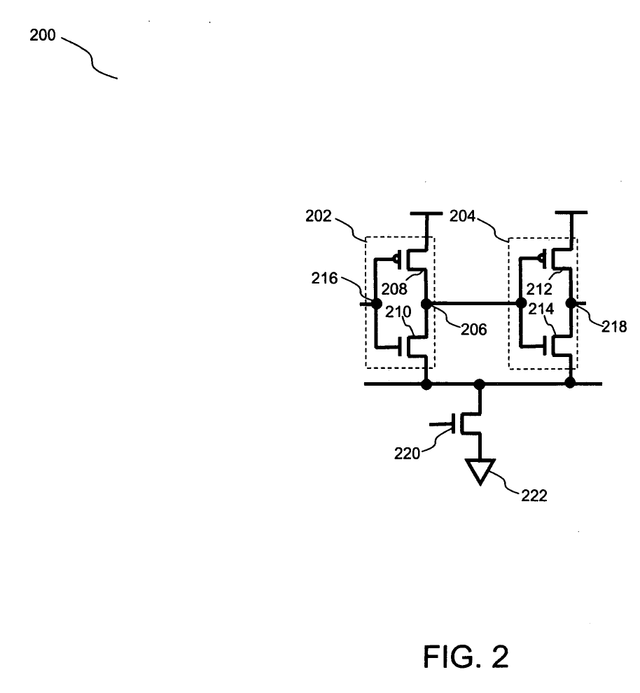

FIG. 2 illustrates a circuit system 200 for reducing the sleep-mode leakage current of an IC in accordance with one embodiment of the present invention. In the circuit system 200, both an NMOS transistor 220 and a bias module 222 are used for reducing the leakage current. As shown, two inverters 202 and 204 are connected together at a node 206, which can be seen as the output node for the inverter 202 and the input node for the inverter 204. The inverter 202 includes a PMOS transistor 208 and an NMOS transistor 210, while the inverter 204 includes a PMOS transistor 212 and an NMOS transistor 214. The gates of the PMOS transistor 208 and the NMOS transistor 210 are coupled together at a node 216, which is also the input node of the circuit system 200. The drains of the PMOS transistor 208 and the NMOS transistor 210 are also coupled with the gates of the PMOS transistor 212 and the NMOS transistor 214 via the node 206. The drains of the PMOS transistor 212 and the NMOS transistor 214 are coupled together at a node 218, which serves as the output node for the circuit system 200. The sources of the PMOS transistors 208 and 212 are both tied to a supply voltage source, while the sources of the NMOS transistors 210 and 214 are both tied to a drain of the NMOS transistor 220. The bias module 222 is implemented at the source of the NMOS transistor 220.

Since both inverters 202 and 204 are connected in series, the signals at the nodes 216 and 218 are designed to be the invert of the signal at the node 206. In other words, when the nodes 216 and 218 are at a low state, the node 206 is designed be at a high state. This means that only one of the two PMOS transistors 208 and 212 can be turned on at one time, and only one of the two NMOS transistors 210 and 214 can be turned on at one time.

The bias module 222 is designed to set a source bias voltage, for example, at approximately 200 mV during the sleep mode. With an increased source bias voltage, the sleep-mode leakage current can be reduced since the voltage source bias 222 is designed to provide a high leakage reduction for one of the NMOS transistors 210 and 214 that is in the off state. Meanwhile, during the sleep mode, a low signal is provided to the gate of the NMOS transistor 220 to turn it off, thereby significantly reducing the leakage current for the inverter that is implemented with the NMOS transistor that is turned on. It is noteworthy that a high signal is used to turn on the NMOS transistor 220 during the normal operation of the system 200. In other words, during the sleep mode, the NMOS transistor 220 is turned off and the bias module generates the bias voltage to reduce the leakage current flowing from the supply voltage source to the NMOS transistors 210 and 214.

By combining both the NMOS transistor 220 and the bias module 222, the leakage current for both inverters 202 and 204 can be significantly reduced by, for example, approximately 100 times as opposed to a circuit without any leakage reduction scheme implemented. The reduction of sleep mode leakage current provides significant benefits, specifically for the ICs that are made using submicron technologies.

It is noted that the size of the NMOS transistor 220 has a trade-off effect between the circuit performance and the efficiency of leakage reduction. For example, if the NMOS transistor 220 is too small, a large voltage drop across the transistor will occur, and the performance of the circuit will suffer. If the NMOS transistor 220 is too large, the voltage drop across the transistor will be smaller, but at the expense of increased leakage current.

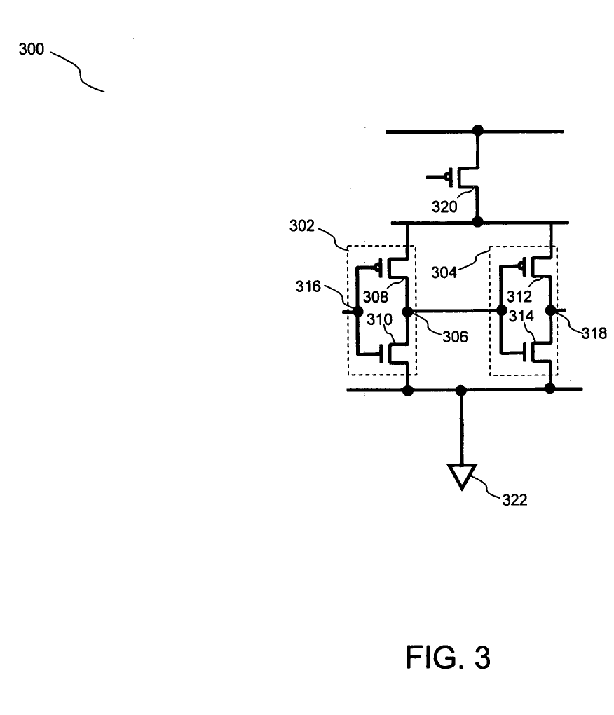

FIG. 3 illustrates a circuit system 300 for reducing the sleep-mode leakage current of an IC in accordance with another embodiment of the present invention. In the circuit system 300, both a PMOS transistor 320 and a bias module 322 are used for reducing the leakage current. As shown, two inverters 302 and 304 are connected together at a node 306, which can be seen as the output node for the inverter 302 and the input node for the inverter 304. The inverter 302 includes a PMOS transistor 308 and an NMOS transistor 310, while the inverter 304 includes a PMOS transistor 312 and an NMOS transistor 314. The gates of the PMOS transistor 308 and the NMOS transistor 310 are coupled together at a node 316, which is also the input node of the circuit system 300. The drains of the PMOS transistor 308 and the NMOS transistor 310 are also coupled with the gates of the PMOS transistor 312 and the NMOS transistor 314 via the node 306. The drains of the PMOS transistor 312 and the NMOS transistor 314 are coupled together at a node 318, which serves as the output node for the circuit system 300. The sources of the NMOS transistors 310 and 314 are coupled to the bias module 322, while the sources of the PMOS transistors 308 and 312 are coupled to the drain of the PMOS transistor 320, whose drain is further connected to a supply voltage source.

During the sleep mode, a high voltage is applied to the gate of the PMOS transistor 320 to turn it off. The PMOS transistor 320 is provided with a source bias voltage slightly lower than the normal supply voltage. For example, the source bias voltage for the PMOS transistor 320 can be lower than the normal supply voltage by 200 mV. As a result, the gate-to-source voltage for the PMOS transistor 320 is increased, and the leakage current from the supply voltage source to the bias module 322 is therefore reduced.

It is noted that the bias module 322 can generate a source bias voltage slightly higher than the normal ground voltage or simply function as ground during the sleep mode. If the bias module 322 generates the source bias voltage, the leakage current will be further reduced. It is also noted that, in another embodiment, the NMOS transistor 220 shown in FIG. 2 can also be implement in the circuit system 300 in combination with the PMOS transistor 320 for further reducing the leakage current.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system for reducing a leakage current of an integrated circuit coupled to a supply voltage source, comprising:
a bias module; and
a switch device serially coupled between the bias module and the integrated circuit,
wherein the bias module generates a bias voltage and the switch device is turned off for reducing the leakage current of the integrated circuit when the integrated circuit is in a sleep mode.

2. The system of claim 1, wherein the switch device is an NMOS transistor.

3. The system of claim 2, wherein the bias voltage at a source of the NMOS transistor is higher than a ground voltage during the sleep mode.

4. The system of claim 3, wherein the bias voltage is higher than the ground. voltage approximately by 200 mV.

5. The system of claim 1, wherein the switch device is a PMOS transistor.

6. The system of claim 5, wherein the bias voltage at a source of the PMOS transistor is lower than a supply voltage during the sleep mode.

7. The system of claim 6, wherein the bias voltage is lower than the supply voltage approximately by 200 mV.

8. The system of claim 1, wherein the integrated circuit comprises a first inverter coupled between the supply voltage source and the switch device.

9. The system of claim 8, wherein the integrated circuit comprises a second inverter coupled between the supply voltage source and the switch device, the second inverter having an input node coupled to an output node of the first inverter.

10. The system of claim 9, wherein the first inverter comprises a first PMOS transistor coupled to the supply voltage source, and a first NMOS transistor serially coupled between the first PMOS transistor and the switch device.

11. The system of claim 10, wherein the second inverter comprises a second PMOS transistor coupled to the supply voltage, and a second NMOS transistor serially coupled between the second PMOS transistor and the switch device, the gates of the second PMOS and NMOS transistors being coupled together at the drains of the first PMOS and NMOS transistors.

12. A method for reducing a leakage current of an integrated circuit during a sleep mode, the method comprising:
turning off a switch device coupled to the integrated circuit for reducing the leakage current flowing through the integrated circuit; and
providing the switch device with a source bias voltage for further reducing the leakage current flowing through the integrated circuit.

13. The method of claim 12, wherein the switch device is an NMOS transistor.

14. The method of claim 13, wherein the source bias voltage for the NMOS transistor is higher than a ground voltage during the sleep mode.

15. The method of claim 12, wherein the switch device is a PMOS transistor.

16. The method of claim 15, wherein the source bias voltage for the PMOS transistor is lower than a supply voltage during the sleep mode.

17. A system for reducing a leakage current of an integrated circuit, comprising:
a bias module; and
an NMOS transistor having a drain coupled to the integrated circuit and a source coupled to the bias module,
wherein when the integrated circuit is in a sleep mode, the bias module generates a first source bias voltage higher than a ground voltage for the NMOS transistor and the NMOS transistor is turned off for reducing the leakage current of the integrated circuit.

18. The system of claim 17 further comprising a PMOS transistor coupled between the integrated circuit and a supply voltage source for further reducing the leakage current during the sleep mode.

19. The system of claim 18 wherein a source of the PMOS transistor is provided with a second source bias voltage lower than a supply voltage during the sleep mode.

20. The system of claim 19 wherein the first source bias is higher than the ground voltage approximately by 200 mV, and the second source bias is lower than the supply voltage approximately by 200 mV.
